(19) United States
(12) Patent Application Publication
(10) Pub. No.: US 2008/0281941 A1
(43) Pub. Date: Nov. 13, 2008

(54) System and method of processing online advertisement selections

(75) Inventors: Sun-uk Park, Union City, CA (US); Zhi Li, San Ramon, CA (US); Canhui Ou, Danville, CA (US); Raghvendra Savoor, Walnut Creek, CA (US); Stephen Sposato, Lafayette, CA (US)

Correspondence Address: TOLER LAW GROUP, 8500 BLUFFSTONE COVE, SUITE A201, AUSTIN, TX, 78759, US

(73) Assignee: AT&T Knowledge Ventures, LP, Reno, NV (US)

(21) Appl. No.: 11/800,966

(22) Filed: May 8, 2007

(51) Int. Cl. G06F 15/16

(52) U.S. Cl. 709/217

(57) ABSTRACT

A method of processing online advertisement selections includes detecting an electronic selection of an online advertisement, where the electronic selection is issued from a user computing device. The method also includes identifying an online site with which the user computing device is communicating at a time of the electronic selection of the online advertisement. The method also includes storing a fraudulent click indicator in association with an identifier of the user computing device, when the user computing device has not communicated with the online site a threshold number of times within a first pre-defined period preceding the electronic selection.

### FIELD OF THE DISCLOSURE

The present disclosure is generally related to processing online advertisement selections.

### BACKGROUND

The Internet can provide a source of revenue for many businesses. Many highly-trafficked online sites allow businesses to focus their advertising efforts and to reduce advertising expenses by using pay-per-click advertising. Pay-per-click advertising generally allows a business to post an advertisement at an online site, such as a search engine site, a news site, or other online site, and to pay for the advertisement based on how many viewers “click” on (i.e., select) the advertisement, in order to access the advertiser's online site or to acquire more information related to the advertisement. Dishonest individuals and business competitors may exploit pay-per-click advertising by repeatedly clicking on online advertisements. This so-called “click fraud” unfairly increases costs to the advertisers and can also expose search engine operators and other entities that offer online advertisement at their sites to liability. Typically, techniques for identifying click-fraud either cannot distinguish legitimate users from non-legitimate users, or they present inconvenience to legitimate users, particularly at search engines and other public sites with no user name or password requirement. Hence, there is a need for an improved system and method of processing online advertisement requests.

### BRIEF DESCRIPTION OF THE DRAWINGS

FIG. 1 is a block diagram of a particular embodiment of a system to process online advertisement selections;

FIG. 2 is a block diagram of a second particular embodiment of a system to process online advertisement selections;

FIG. 3 is a block diagram of a third particular embodiment of a system to process online advertisement selections;

FIG. 4 is a flow diagram of a particular embodiment of a method of processing online advertisement selections;

FIG. 5 is a flow diagram of a second particular embodiment of a method of processing online advertisement selections;

FIG. 6 is a flow diagram of a third particular embodiment of a method of processing online advertisement selections;

FIG. 7 is a flow diagram of a fourth particular embodiment of a method of processing online advertisement selections; and

FIG. 8 is a diagram of an illustrative embodiment of a general computer system.

### DETAILED DESCRIPTION OF THE DRAWINGS

A system to process online advertisement selections is disclosed and includes an analysis engine operable to receive data from a deep packet inspection (DPI) device indicating an electronic selection of an online advertisement issued by a user computing device. The analysis engine is also operable to retrieve historical data associated with the user computing device from a data store. The analysis engine is also operable to request data from an advertisement broker device identifying an online site with which the user computing device is communicating at a time of the electronic selection of the online advertisement. Further, the analysis engine is operable to determine, based on the historical data, whether the user computing device has communicated with the online site a threshold number of times within a pre-defined period preceding the electronic selection. In addition, the analysis engine is operable to store a fraudulent click indicator in association with an identifier of the user computing device, when the user computing device has not communicated with the online site a threshold number of times within a first pre-defined period preceding the electronic selection.

In another embodiment, a method of processing online advertisement selections is disclosed and includes detecting an electronic selection of an online advertisement, where the electronic selection is issued from a user computing device. The method also includes identifying an online site with which the user computing device is communicating at a time of the electronic selection of the online advertisement. The method also includes storing a fraudulent click indicator in association with an identifier of the user computing device, when the user computing device has not communicated with the online site a threshold number of times within a first pre-defined period preceding the electronic selection.

In another embodiment, a method of processing online advertisement selections is disclosed and includes detecting a hypertext transfer protocol (HTTP) request associated with an online advertisement, where the HTTP request is issued from a user computing device. The method also includes identifying an ad location corresponding to the online advertisement, the ad location comprising an online site with which the user computing device is communicating at a time of the HTTP request associated with the online advertisement. The method also includes storing a fraudulent click indicator in association with an identifier of the user computing device, when a pre-defined number of previous HTTP requests issued from the user computing device do not include a threshold number of other HTTP requests associated with the online site.

In another embodiment, a method of processing online advertisement selections is disclosed and includes detecting an electronic selection of an online advertisement, where the electronic selection is issued from a user computing device. The method also includes receiving data from an advertiser associated with the online advertisement, the data indicating user behavior associated with the user computing device prior to the electronic selection. The method also includes selectively storing a fraudulent click indicator in association with an identifier of the user computing device based on the data received from the advertiser.

In another embodiment, a computer-readable medium is disclosed and includes processor-readable instructions adapted to cause a-processor to execute a method comprising detecting an electronic selection of an online advertisement issued from a user computing device, identifying an online site with which the user computing device is communicating at a time of the electronic selection of the online advertisement, and storing a fraudulent click indicator in association with an identifier of the user computing device, when the user computing device has not communicated with the online site a threshold number of times within a first pre-defined period preceding the electronic selection.

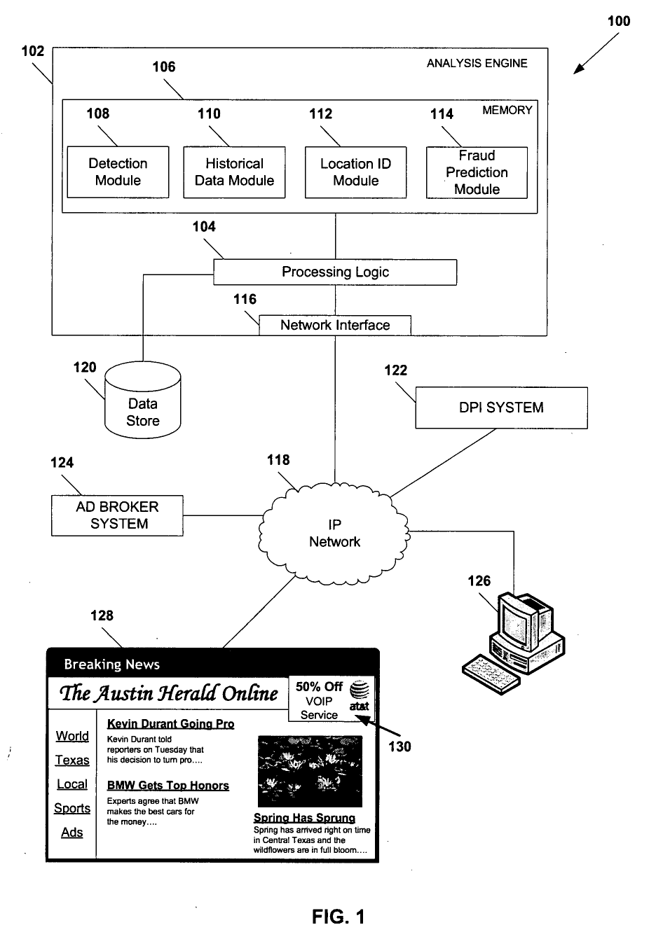

Referring to FIG. 1, a block diagram of a particular embodiment of a system to process online advertisement selections is illustrated and designated generally 100. The system includes an analysis engine 102 that communicates with an Internet Protocol (IP) network 118. The IP network 118 can include a public data network, such as the Internet, or a private IP network. In an alternative embodiment, the analysis engine 102 can communicate with the Internet via a private IP network. The analysis engine 102 can include one or more servers or other devices that include logic and memory that are independent, redundant or a combination thereof.

The analysis engine also communicates with a data store 120 that stores historical data associated with user computing devices. In a particular embodiment, the analysis engine 102 can communicate with a deep packet inspection (DPI) device 122 that examines data packets sent to and from user computing devices via the IP network 118. In an illustrative embodiment, the analysis engine 102 can communicate with an advertisement broker system 124 that stores data identifying online sites at which online advertisements are located.

In a particular illustrative embodiment, a user computer 126 communicating with the IP network 118 can access an online site 128 that includes one or more online advertisements, such as the online advertisement 130. The online advertisement 130 can be located at an online site 128 of the advertiser or another entity, such as a news provider. The online advertisement 130 may include an embedded graphics link to the advertiser's online site or to a page or pop-up window displaying additional information related to the advertiser, the online advertisement, or any combination thereof.

In a particular embodiment, the user computer 126 can issue an electronic selection of the online advertisement 130. For example, a user can “click” on the online advertisement 130 using a mouse, and the user computer can send a data packet indicating a selection of the online advertisement to a web server associated with the ad location (e.g., the news provider's online site 128). The DPI device 122 can examine the data packet and determine that the user computing device 126 has issued an electronic selection of the online advertisement 130. The DPI device 122 can send data indicating the electronic selection to the analysis engine 102.

The analysis engine 102 includes processing logic 104 that communicates with the IP network 118 via a network interface 116. The analysis engine 102 also includes memory 106 accessible to the processing logic 104. The memory 106 can store instructions that are executable by the processing logic 104 to perform various functions of the analysis engine 102. Such instructions are represented as modules 108-114. In alternative embodiments, one or more of the functions provided by the modules 108-114 may be implemented using hardware logic.

In a particular embodiment, the memory 106 can include a detection module 108 that is executable by the processing logic 104 to detect electronic selections of online advertisements by user computing devices. For example, the detection module 108 can be executable by the processing logic 104 to receive data from the DPI device 122 indicating an electronic selection of the online advertisement 130 issued from the user computing device 126. In an illustrative, non-limiting embodiment, the detection module 108 can be executable by the processing logic 104 to determine whether a number of online advertisement selections issued from the user computing device 126, such as a number of online advertisement selections during an Internet session, a number of online advertisement selections during a period of time, a number of electronic selections of the particular online advertisement 130, a number of electronic selections of online advertisements related to the particular online advertisement 130, or any combination thereof, meets or exceeds a threshold, as a result of the detected electronic selection before fraud determination or prediction functions of the analysis engine 102 are invoked.

In a particular embodiment, the memory 106 can include a historical data module 110 that is executable by the processing logic 104 to receive historical data related to the user computing device 126 in response to the electronic selection of the online advertisement 130. For example, the historical data module 110 can be executable by the processing logic 104 to request historical clickstream data associated with the user computing device 126 from the data store 120. The historical data can indicate online sites with which the user computing device 126 has communicated within a pre-defined period. In an illustrative embodiment, the historical data can also include selections, search queries and other activities of the user computing device 126 when communicating with such online sites during the pre-defined period. In another illustrative embodiment, the historical data can include a number of fraudulent click indicators associated with the user computing device 126 prior to the detected electronic selection.

In a particular embodiment, the DPI device 122 can collect the historical data and send it to the data store 120 for storage in association with an identifier of the user computing device 126. In another embodiment, the historical data module 110 can be executable by the processing logic 104 to collect the historical data and send it to the data store 120. In still another embodiment, the data store 120 can include logic to collect and store the historical data.

In a particular embodiment, the memory 106 can include a location identification (ID) module 112 that is executable by the processing logic 104 to identify an ad location of the selected online advertisement 130. The ad location includes an online site 128 with which the user computing device 126 is communicating at a time of the electronic selection of the online advertisement 130. For example, the location ID module 112 can be executable by the processing logic 104 to send data related to the online advertisement to the advertisement broker system 124 and to receive data indicating an ad location of the online advertisement 130, such as a uniform resource locator (URL) of an online news site.

In a particular embodiment, the memory 106 can include a fraud prediction module 114 that is executable by the processing logic 104 to determine based at least partially on the historical data whether the user computing device has communicated with the ad location a threshold number of times during a pre-defined period preceding the detected electronic selection, such as once within the last three months or three times within the last six months. Further, the fraud prediction module 114 can be executable by the processing logic 104 to store a fraudulent click indicator at the data store 120 in association with the an identifier of the user computing device 126, such as an IP address, when the user computing device 126 has not communicated with the ad location the threshold number of times within the pre-defined period preceding the detected electronic selection of the online advertisement 130. In addition, the fraud prediction module 114 can be executable by the processing logic 104 to determine whether a total number of fraudulent click indicators associated with the identifier of the user computing device meets or exceeds pre-determined number of fraudulent click indicators and to store a fraudulent user indicator in association with the identifier of the user computing device when the total number meets or exceeds the pre-determined number of fraudulent click indicators.

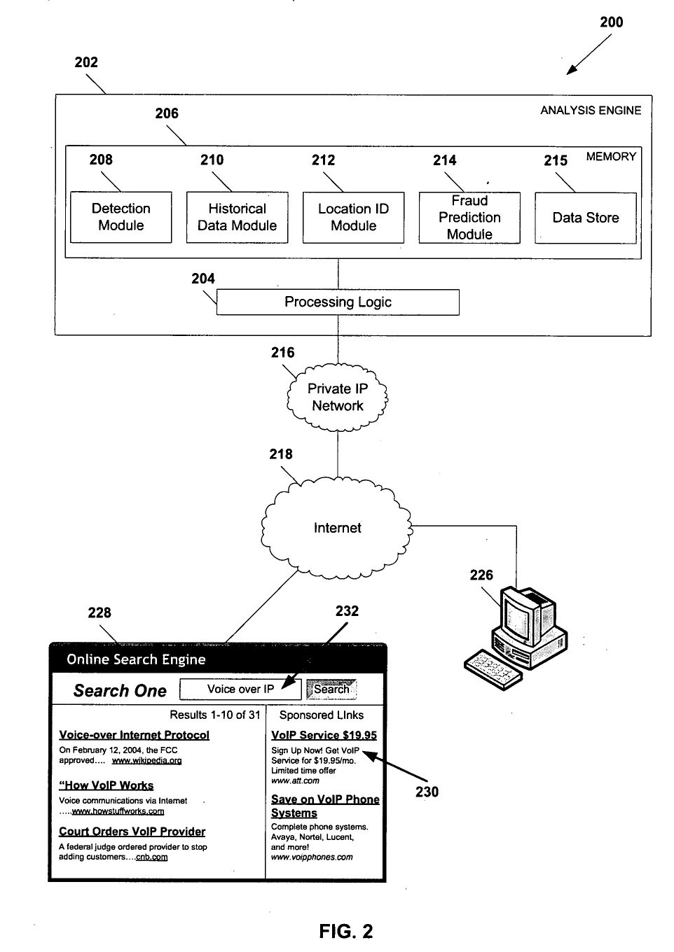

Referring to FIG. 2, a block diagram of a second particular embodiment of a system to process online advertisement selections is illustrated and designated generally 200. The system includes an analysis engine 202,that communicates with the Internet 218 via a private Internet Protocol (IP) network 216. The analysis engine 202 includes processing logic 204 that communicates with the Internet 218 via the private IP network 216. The analysis engine 202 also includes memory 206 accessible to the processing logic 204. The memory 206 can store instructions that are executable by the processing logic 204 to perform various functions of the analysis engine 202. Such instructions are represented as modules 208-215. In alternative embodiments, one or more of the functions provided by the modules 208-215 may be implemented using hardware logic.

In a particular illustrative embodiment, a user computer 226 communicating with the Internet 218 can access an online site 228 that includes one or more online advertisements, such as the online advertisement 230. The online advertisement 230 can be located at an online site of the advertiser or another entity, such as a search engine provider. The online advertisement 230 may include an advertisement that is displayed with search results in response to a current search query 232, where the advertisement includes a link to the advertiser's online site. In a particular embodiment, the user computer 226 can issue an electronic selection of the online advertisement 230. For example, the user computing device 226 can issue a hypertext transfer protocol (HTTP) request associated with the online advertisement 230, and the user computer can send a data packet indicating the HTTP request to a web server associated with the ad location (e.g., the search engine site 228).

In a particular embodiment, the memory 206 can include a detection module 208 that is executable by the processing logic 204 to detect electronic selections of online advertisements by user computing devices. For example, the detection module 208 can be executable by the processing logic 204 to detect and examine a data packet issued from the user computing device 226 that includes a HTTP request or other electronic selection associated with the online advertisement 230. In an illustrative, non-limiting embodiment, the detection module 208 can be executable by the processing logic 204 to determine whether a number of online advertisement selections issued from the user computing device 226, such as a number of HTTP requests during an Internet session, a number of HTTP requests during a period of time, a number of HTTP requests associated with the particular online advertisement 230, a number of HTTP requests associated with online advertisements related to the particular online advertisement 230, or any combination thereof, meets or exceeds a threshold, as a result of the detected electronic selection before fraud determination or prediction functions of the analysis engine 202 are invoked.

In a particular embodiment, the memory 206 can include a historical data module 210 that is executable by the processing logic 204 to receive historical data related to the user computing device 226 in response to the electronic selection of the online advertisement 230. For example, the processing logic 204 can access historical data at the data store 215, which can include HTTP requests, other electronic selections, search queries and other activities of the user computing device when communicating with online sites during a pre-defined period prior to the detected electronic selection. In another illustrative embodiment, the historical data can include a number of fraudulent click indicators associated with the user computing device 226. In a particular embodiment, the analysis engine can 202 collect the historical data and tore it at the data store 222 in association with an identifier of the user computing device 226.

In a particular embodiment, the memory 206 can include a location identification (ID) module 212 that is executable by the processing logic 204 to identify an ad location of the selected online advertisement 230. The ad location includes an online site 228 with which the user computing device 226 was communicating when the electronic selection was made. For example, the location ID module 212 can be executable by the processing logic 204 to identify the ad location of the online advertisement 230 by inspecting the data packet corresponding to the electronic selection, such as a uniform resource locator (URL) of the search engine site.

In a particular embodiment, the memory 206 can include a fraud prediction module 214 that is executable by the processing logic 204 to determine based at least partially on the historical data whether a pre-defined number of HTTP requests or other electronic selections includes a threshold number of other HTTP requests or other electronic selections associated with the search engine site 228. Further, the fraud prediction module 214 can be executable by the processing logic 204 to store a fraudulent click indicator at the data store 215 in association with the an identifier of the user computing device 226, such as an IP address, when the user computing device 226 pre-defined number of HTTP requests or other electronic selections does not include the threshold number of other HTTP requests or other electronic selections associated with the search engine site 228.

In a particular embodiment, the fraud detection module 214 can be executable by the processing logic 204 to identify the current search query 232 when the pre-defined number of HTTP requests or other electronic selections includes the threshold number of other HTTP requests or other electronic selections associated with the search engine site 228. Further, the fraud detection module 214 can be executable by the processing logic 204 to determine whether the user computing device 226 has submitted a search query related to the current search query 232 within a pre-defined period. For example, if the pre-defined number of HTTP requests or other electronic selections includes a threshold number of other HTTP requests or other electronic selections associated with the search engine site 228, the analysis engine 202 can determine whether the user computing device 226 has submitted one or more search queries related to the current search query 232 within the three months preceding the detected electronic selection at the search engine site 228, at other search engine sites, or any combination thereof. The fraud prediction module 214 can be executable by the processing logic 204 to store a fraudulent click indicator at the data store 215 in association with the an identifier of the user computing device 226 when the user computing device 226 has not issued such search queries within the pre-defined period.

In addition, the fraud prediction module 214 can be executable by the processing logic 204 to determine whether a total number of fraudulent click indicators associated with the identifier of the user computing device meets or exceeds pre-determined number of fraudulent click indicators and to store a fraudulent user indicator in association with the identifier of the user computing device when the total number meets or exceeds the pre-determined number of fraudulent click indicators.

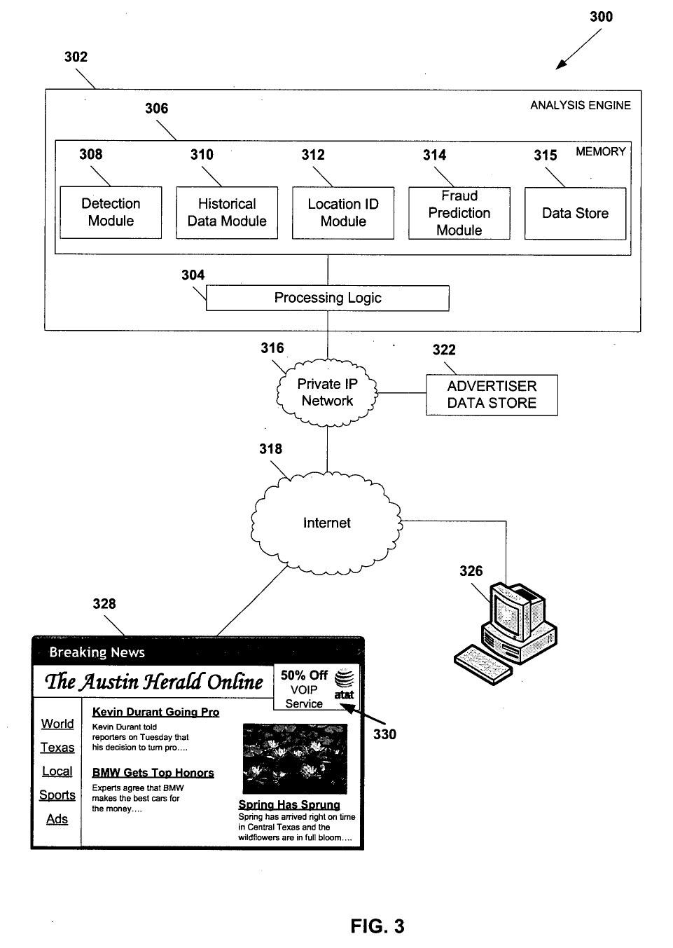

Referring to FIG. 3, a block diagram of a third particular embodiment of a system to process online advertisement selections is illustrated and designated generally 300. The system includes an analysis engine 302 that communicates with the Internet 318 via a private Internet Protocol (IP) network 316. In a particular embodiment, the analysis engine 302 can communicate with an advertiser data store 322 via the private IP network 216 or, alternatively, via the Internet 318.

The analysis engine 302 includes processing logic 304 that communicates with the Internet 318 via the private IP network 316. The analysis engine 302 also includes memory 306 accessible to the processing logic 304. The memory 306 can store instructions that are executable by the processing logic 304 to perform various functions of the analysis engine 302. Such instructions are represented as modules 308-215. In alternative embodiments, one or more of the functions provided by the modules 308-315 may be implemented using hardware logic.

In a particular illustrative embodiment, a user computer 326 communicating with the Internet 318 can access an online site 328 that includes one or more online advertisements, such as the online advertisement 330. The online advertisement 330 can be located at an online site 328 of the advertiser or another entity, such as a news provider. The online advertisement 330 may include an embedded graphics link to the advertiser's online site or to a page or pop-up window displaying additional information related to the advertiser, the online advertisement, or any combination thereof. The user computer 326 can issue an electronic selection of the online advertisement 330. For example, a user can “click” on the online advertisement 330 using a mouse, and the user computer can send a data packet indicating a selection of the online advertisement to a web server associated with the ad location (e.g., the news provider's online site 328).

In a particular embodiment, the memory 306 can include a detection module 308 that is executable by the processing logic 304 to detect electronic selections of online advertisements by user computing devices. For example, the detection module 308 can be executable by the processing logic 304 to detect and examine a data packet issued from the user computing device 326 that includes an electronic selection of the online advertisement 330. In an illustrative, non-limiting embodiment, the detection module 308 can be executable by the processing logic 304 to determine whether a number of online advertisement selections issued from the user computing device 326, such as a number of electronic selections of online advertisements during an Internet session, a number of electronic selections of online advertisements during a period of time, a number of electronic selections of the particular online advertisement 330 (e.g., successive selections), a number of electronic selections of online advertisements related to the particular online advertisement 330, or any combination thereof, meets or exceeds a threshold, as a result of the detected electronic selection before fraud determination or prediction functions of the analysis engine 302 are invoked.

In a particular embodiment, the memory 306 can include a historical data module 310 that is executable by the processing logic 304 to receive historical data related to the user computing device 326 in response to the electronic selection of the online advertisement 330. For example, the processing logic 304 can access historical data at the data store 315, which can include HTTP requests, other electronic selections, search queries and other activities of the user computing device when communicating with online sites during a pre-defined period prior to the detected electronic selection. In another illustrative embodiment, the historical data can include a number of fraudulent click indicators associated with the user computing device 326. In a particular embodiment, the analysis engine can 302 collect the historical data and store it at the data store 322 in association with an identifier of the user computing device 326.

Further, in a particular embodiment, the historical data module 310 can be executable by the processing logic 304 to request historical data associated with the user computing device 326 from the advertiser data store 322 that is associated with the advertiser whose advertisement 330 was selected. The historical data received from the advertiser data store 322 can indicate selections of online advertisements of the advertiser, visits to the advertiser's website, post-selection data, such as data indicating fulfillment activities associated with prior communications between the user computing device 326 and the advertiser (e.g., requests for information about the advertiser, requests for information related to goods or services of the advertiser, or purchases of goods or services from the advertiser), other activities related to the advertiser, or any combination thereof, within a pre-defined period. Requests for information can include navigation among various pages of the advertiser's online site

In a particular embodiment, the memory 306 can include a location identification (ID) module 312 that is executable by the processing logic 304 to identify an ad location of the selected online advertisement 330. The ad location includes an online site 328 with which the user computing device 326 was communicating when the electronic selection was made. For example, the location ID module 312 can be executable by the processing logic 304 to identify the ad location of the online advertisement 330 by inspecting the data packet corresponding to the electronic selection, such as a uniform resource locator (URL) of the online news site 328.

In a particular embodiment, the memory 306 can include a fraud prediction module 314 that is executable by the processing logic 304 to selectively store a fraudulent click indicator in association with an identifier of the user computing device 326 based on the historical data stored at the data store 315, the historical data received from the advertiser data store 322, or a combination thereof. In an illustrative embodiment, the fraud prediction module 314 can be executable by the processing logic 304 to determine whether an average number of times that the user computing device 326 has communicated with the online site 328 during a plurality of pre-defined periods equals or exceeds a threshold. The fraud prediction module 314 can be executable by the processing logic 304 to store a fraudulent click indicator at the data store 315 in association with the an identifier of the user computing device 326, in response to the detected electronic selection of the online advertisement 330, when the average number does not equal or exceed the threshold. In another embodiment, the fraud prediction module 314 can be executable by the processing logic 304 to determine whether historical data received from the advertiser data store 322 includes post-selection data that indicates fulfillment activities associated with a pre-determined number of prior communications between the user computing device 326 and the advertiser's online site. The fraud prediction module 314 can be executable by the processing logic 304 to store a fraudulent click indicator at the data store 315 in association with the an identifier of the user computing device, in response to the detected electronic selection of the online advertisement 330, when the post-selection data that indicates fulfillment activities associated with a pre-determined number of prior communications between the user computing device 326 and the advertiser's online site. In an illustrative, non-limiting embodiment, the fraud prediction module 314 can be executable by the processing logic 304 to remove a fraudulent click indicator stored in response to the detected electronic selection of the online advertisement 330, when one or more fulfillment activities are detected during a session between the user computing device 326 and the advertiser's online site, where the session results from the detected electronic selection of the online advertisement.

In addition, the fraud prediction module 314 can be executable by the processing logic 304 to determine whether a total number of fraudulent click indicators associated with the identifier of the user computing device meets or exceeds pre-determined number of fraudulent click indicators and to store a fraudulent user indicator in association with the identifier of the user computing device when the total number meets or exceeds the pre-determined number of fraudulent click indicators.

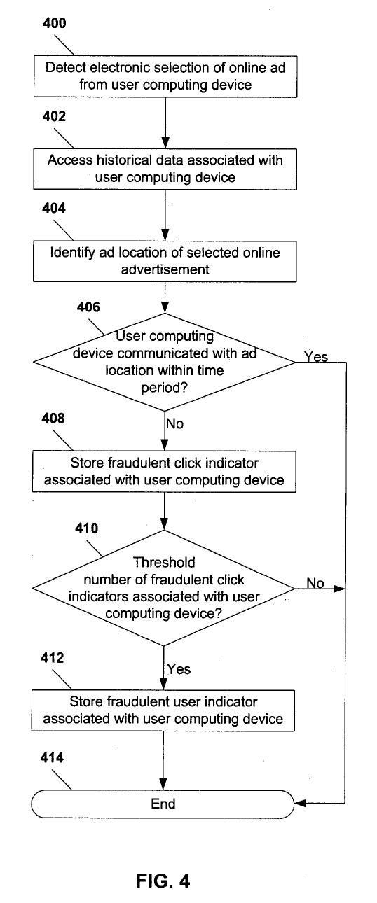

Referring to FIG. 4, a flow diagram of a particular embodiment of a method of processing online advertisement selections is illustrated. At block 400, an electronic selection of an online advertisement issued from a user computing device is detected at an analysis engine. The electronic selection can be detected by the analysis engine or as a result of the analysis engine receiving data indicating the electronic selection from a deep packet inspection (DPI) device or other system communicating with the analysis engine. The online advertisement can include, for example, an embedded graphics link or an advertisement included with search results at a search engine site.

Moving to block 402, the analysis engine accesses historical data associated with the user computing device. The analysis engine can access the historical data within memory of the analysis engine, at an advertiser data store or other data store communicating with the analysis engine, or any combination thereof. The historical data can indicate online sites with which the user computing device has communicated within a pre-defined period. In an illustrative embodiment, the historical data can also include selections, search queries and other activities of the user computing device when communicating with such online sites during the pre-defined period. In another illustrative embodiment, the historical data can include a number of fraudulent click indicators associated with the user computing device prior to the detected electronic selection.

Proceeding to block 404, the analysis engine identifies an ad location of the selected online advertisement. The ad location includes an online site with which the user computing device was communicating when the electronic selection was made. For example, if an online advertisement is included with search results at a search engine site, the search engine site would be identified as the ad location. Whereas, if the online advertisement includes an embedded graphics link at an online news site, the online news site would be identified as the ad location.

Continuing to decision node 406, the analysis engine determines based at least partially on the historical data whether the user computing device has communicated with the ad location within a pre-defined period prior to the detected electronic selection. If the user computing device has communicated with the ad location with the pre-defined period, the method terminates at 414. Conversely, if the user computing device has not communicated with the ad location with the pre-defined period, the method advances to block 408, and the analysis engine can store a fraudulent click indicator in association with an identifier of the user computing device within memory of the analysis engine or at a data store communicating with the analysis engine.

At decision node 410, in a particular embodiment, the analysis engine can determine whether a threshold number of fraudulent click indicators are associated with the user computing device as a result of the fraudulent click indicator corresponding to the detected electronic selection of the online advertisement. If the threshold number of fraudulent click indicators has been met or exceeded, the method can proceed to block 412, and the analysis engine can store a fraudulent user indicator in association with the identifier of the user computing device within memory of the analysis engine or at a data store communicating with the analysis engine. The method terminates at 414.

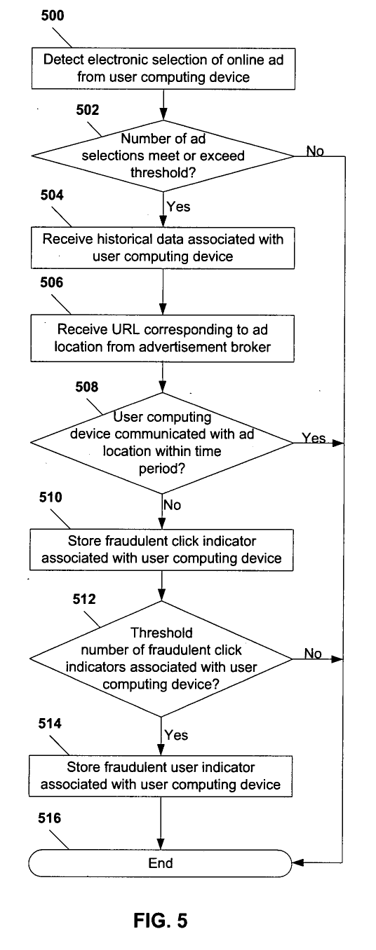

Referring to FIG. 5, a flow diagram of a second particular embodiment of a method of processing online advertisement selections is illustrated. At block 500, an electronic selection of an online advertisement issued from a user computing device is detected at an analysis engine. The electronic selection can be detected by the analysis engine or as a result of the analysis engine receiving data indicating the electronic selection from a deep packet inspection (DPI) device or other system communicating with the analysis engine. The online advertisement can include,.for example, an embedded graphics link or an advertisement included with search results at a search engine site.

Moving to decision node 502, in a particular embodiment, the analysis engine can determine whether a number of advertisement selections issued from the user computing device meets or exceeds a threshold as a result of the detected electronic selection. The number of electronic selections can relate to all online advertisements, the selected online advertisement (such as multiple successive selections), online advertisements related to the selected online advertisement, or any combination thereof. If the number of electronic selections does not meet or exceed the threshold, the method can terminate at 516. Whereas, if the number of electronic selections meets or exceeds the threshold, the method proceeds to block 504.

Proceeding to block 504, the analysis engine receives historical data associated with the user computing device. For example, the analysis engine can receive the historical data from an advertiser data store or other data store communicating with the analysis engine. In an alternative embodiment, the analysis engine can access the historical data within memory of the analysis engine. The historical data can indicate online sites with which the user computing device has communicated within a pre-defined period. In an illustrative embodiment, the historical data can also include selections, search queries and other activities of the user computing device when communicating with such online sites during the pre-defined period. In another illustrative embodiment, the historical data can include a number of fraudulent click indicators associated with the user computing device prior to the detected electronic selection.

Continuing to block 506, the analysis engine can receive a uniform resource locator (URL) corresponding to an ad location of the selected online advertisement from an advertisement broker system communicating with the analysis engine. The advertisement broker system can be a system that stores data indicating ad locations associated with various advertisements. The ad location includes an online site with which the user computing device was communicating when the electronic selection was made.

Advancing to decision node 508, the analysis engine determines based at least partially on the historical data whether the user computing device has communicated with the ad location within a pre-defined period prior to the detected electronic selection. If the user computing device has communicated with the ad location with the pre-defined period, the method terminates at 516. Conversely, if the user computing device has not communicated with the ad location with the pre-defined period, the method proceeds to block 510, and the analysis engine can store a fraudulent click indicator in association with an identifier of the user computing device within memory of the analysis engine or at a data store communicating with the analysis engine.

At decision node 512, in a particular embodiment, the analysis engine can determine whether a threshold number of fraudulent click indicators are associated with the user computing device as a result of the fraudulent click indicator corresponding to the detected electronic selection of the online advertisement. If the threshold number of fraudulent click indicators has been met or exceeded, the method can proceed to block 514, and the analysis engine can store a fraudulent user indicator in association with the identifier of the user computing device within memory of the analysis engine or at a data store communicating with the analysis engine. The method terminates at 516.

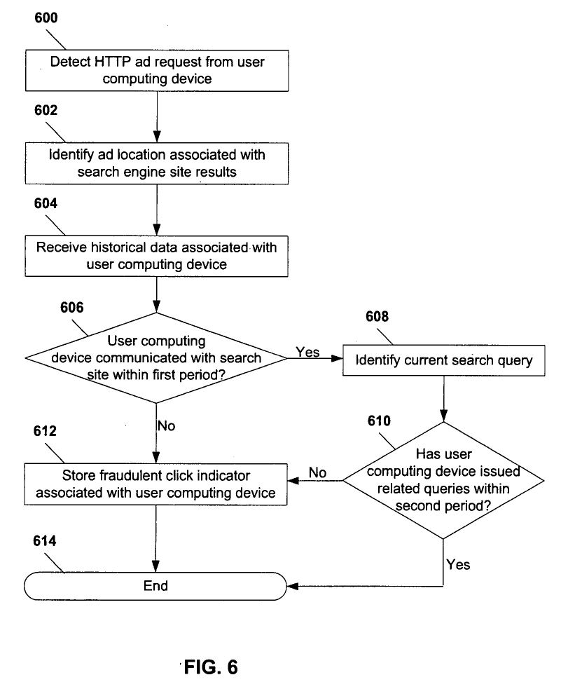

Referring to FIG. 6, a flow diagram of a third particular embodiment of a method of processing online advertisement selections is illustrated. At block 600, a hypertext transfer protocol (HTTP) request issued from a user computing device related to an online advertisement is detected at an analysis engine. The online advertisement can include, for example, an advertisement included with search results at a search engine site. Moving to block 602, the analysis engine identifies an ad location of the selected online advertisement. The ad location includes the search engine site and can be identified by a uniform resource locator (URL) or other identifier.

Proceeding to block 604, the analysis engine receives historical data associated with the user computing device. For example, the analysis engine can receive the historical data from an advertiser data store or other data store communicating with the analysis engine. In an alternative embodiment, the analysis engine can access the historical data within memory of the analysis engine. The historical data can indicate online sites with which the user computing device has communicated within a pre-defined period. In an illustrative embodiment, the historical data can also include selections, search queries and other activities of the user computing device when communicating with such online sites during the pre-defined period. In another illustrative embodiment, the historical data can include a number of fraudulent click indicators associated with the user computing device prior to the detected electronic selection.

Continuing to decision node 606, the analysis engine determines based at least partially on the historical data whether the user computing device has communicated with the search engine site within a first pre-defined period prior to the detected electronic selection. If the user computing device has communicated with the search engine site within the first pre-defined period, the method moves to block 608, and the analysis engine identifies a current search query issued by the user computing device, in response to which the search engine site returned search results including the selected online advertisement.

Advancing to decision node 610, the analysis engine can determine based at least partially on the historical data whether the user computing device has issued queries related to the current search query to the search engine site, to another search engine site, or any combination thereof, within a second pre-defined period, which may be the same as or different than the first pre-defined period. If the analysis engine determines that the user computing engine has issued such queries within the second pre-defined period, the method terminates at 614. Conversely, if the analysis engine determines that the user computing engine has not issued such queries within the second pre-defined period, the method moves to block 612, and the analysis engine can store a fraudulent click indicator in association with an identifier of the user computing device within memory of the analysis engine or at a data store communicating with the analysis engine.

Returning to decision node 606, if the user computing device has not communicated with the ad location with the pre-defined period, the method advances to block 612, and the analysis engine can store a fraudulent click indicator in association with an identifier of the user computing device within memory of the analysis engine or at a data store communicating with the analysis engine. The method terminates at 614.

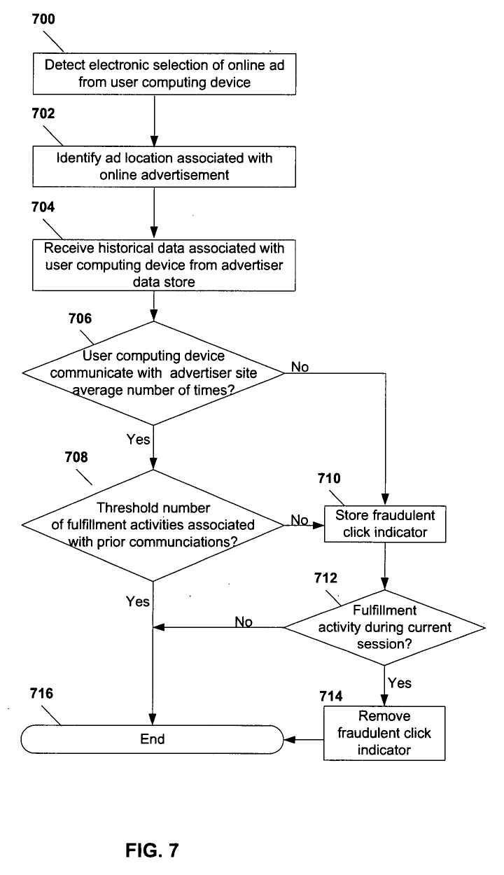

Referring to FIG. 7, a flow diagram of a fourth particular embodiment of a method of processing online advertisement selections is illustrated. At block 700, an electronic selection of an online advertisement issued from a user computing device is detected at an analysis engine. The electronic selection can be detected by the analysis engine or as a result of the analysis engine receiving data indicating the electronic selection from a deep packet inspection (DPI) device or other system communicating with the analysis engine. The online advertisement can include, for example, an embedded graphics link.

Moving to block 702, the analysis engine identifies an ad location of the selected online advertisement. The ad location includes the online site with which the user computing device is communicating at the time of the electronic selection and can be identified by a uniform resource locator (URL) or other identifier of the online site. Proceeding to block 704, the analysis engine receives advertiser-specific historical data associated with the user computing device from an advertiser data associated with the advertiser corresponding to the selected online advertisement. The historical data received from the advertiser data store can indicate selections of online advertisements of the advertiser, visits to the advertiser's website, post-selection data, such as data indicating fulfillment activities associated with prior communications between the user computing device and the advertiser (e.g., requests for information about the advertiser, requests for information related to goods or services of the advertiser, or purchases of goods or services from the advertiser), other activities related to the advertiser, or any combination thereof, within a pre-defined period. Requests for information can include navigation among various pages of the advertiser's online site

Continuing to decision node 706, the analysis engine determines based at least partially on the historical data whether the user computing device has communicated with an online site of the advertiser a pre-determined average number of times within a plurality of periods prior to the detected electronic selection (e.g., at least once a month for the previous six months). If the user computing device has communicated with the search engine site at least the pre-determined average number of times, the method moves to decision node 708, and the analysis engine determines based on the historical data whether a threshold number of fulfillment activities are associated with prior communications between the user computing device and the online site of the advertiser. Fulfillment activities can include requests for information about the advertiser, requests for information related to goods or services of the advertiser, purchases of goods or services from the advertiser, or any combination thereof.

If the threshold number of fulfillment activities are associated with prior communications between the user computing device and the online site of the advertiser, the method can terminate at 716. On the other hand, if the threshold number of fulfillment activities are not associated with prior communications between the user computing device and the online site of the advertiser, the method proceeds to block 710, and the analysis engine can store a fraudulent click indicator in association with an identifier of the user computing device within memory of the analysis engine, at the advertiser data store, at another data store communicating with the analysis engine, or any combination thereof. The method then continues to decision node 712.

Returning to decision node 706, if the user computing device has not communicated with the online site of the advertiser the threshold number of times, the method advances to block 710, and the analysis engine can store a fraudulent click indicator in association with an identifier of the user computing device within memory of the analysis engine, at the advertiser data store, at another data store communicating with the analysis engine, or any combination thereof. The method then continues to decision node 712.

At decision node 712, in an illustrative embodiment, the analysis engine can determine whether a fulfillment activity occurs during a session between the user computing device and the online site of the advertiser, where the session is initiated by or otherwise results from the detected electronic selection of the online advertisement. For example, the analysis engine can receive data from the advertiser data store indicating such a fulfillment activity. If the analysis engine determines that a fulfillment activity occurs during such a session between the user computing device and the online site of the advertiser, the analysis engine can remove the fraudulent click indicator stored at block 710, or cause the indicator to be removed, within memory of the analysis engine, at the advertiser data store, at another data store communicating with the analysis engine, or any combination thereof. The method terminates at 716.

The methods described herein can be performed as presented. Alternatively, those skilled in the art will appreciate that certain aspects of the methods can be performed concurrently or in sequences not presented without departing from the scope of the disclosure. For example, in some embodiments, receiving historical data and identifying an ad location can be performed in any order or simultaneously.

In conjunction with the configuration of structure described herein, systems and methods of processing online advertisement selections are presented that enable a network operator or other party communicating with a public data network to predict and identify click fraud activities. In a particular embodiment, an electronic selection of an online advertisement can be detected, where the electronic selection is issued from a user computing device. An ad location corresponding to the online advertisement can be identified, and a fraudulent click indicator can be selectively stored in association with an identifier of the user computing device when the user computing device has not communicated with the ad location a threshold number of times during a pre-defined period. Thus, in a particular embodiment, click fraud can be detected and recorded in real-time or near real-time, in contrast to mining server logs after the consequences of the click fraud are detected.

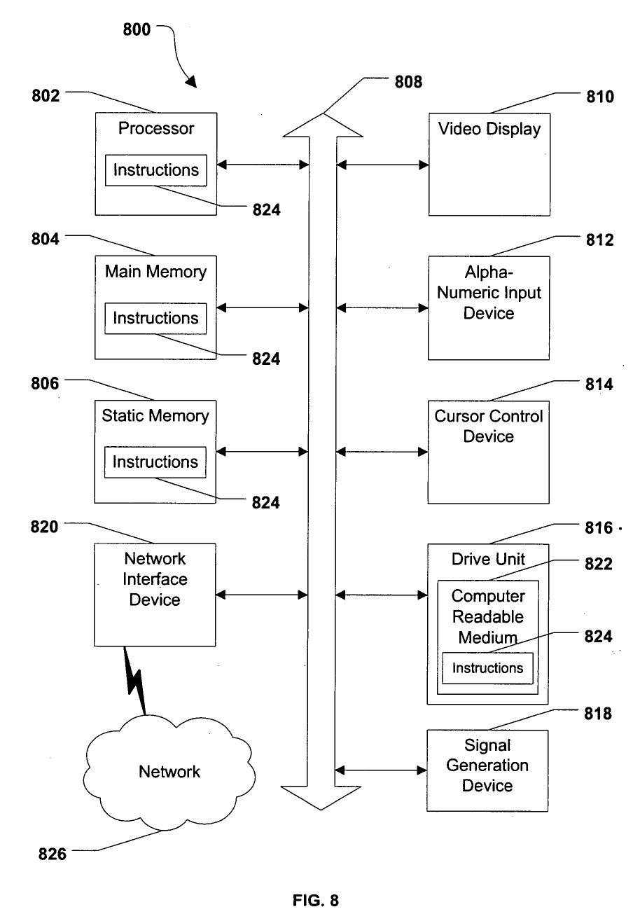

Referring to FIG. 8, an illustrative embodiment of a general computer system is shown and is designated 800. The computer system 800 can include a set of instructions that can be executed to cause the computer system 800 to perform any one or more of the methods or computer based functions disclosed herein. The computer system 800 may operate as a standalone device or may be connected, e.g., using a network, to other computer systems or peripheral devices, such as an analysis engine, advertisement broker system, deep packet inspection device, advertiser data store or other data store, user computing device, or any combination thereof, as illustrated in FIGS. 1-3.

In a networked deployment, the computer system may operate in the capacity of a server or as a client user computer in a server-client user network environment, or as a peer computer system in a peer-to-peer (or distributed) network environment. The computer system 800 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 800 can be implemented using electronic devices that provide voice, video or data communication. Further, while a single computer system 800 is illustrated, the term “system” shall also be taken to include any collection of systems or sub-systems that individually or jointly execute a set, or multiple sets, of instructions to perform one or more computer functions.

As illustrated in FIG. 8, the computer system 800 may include a processor 802, e.g., a central processing unit (CPU), a graphics processing unit (GPU), or both. Moreover, the computer system 800 can include a main memory 804 and a static memory 806 that can communicate with each other via a bus 808. As shown, the computer system 800 may further include a video display unit 810, such as a liquid crystal display (LCD), an organic light emitting diode (OLED), a flat panel display, a solid state display, or a cathode ray tube (CRT). Additionally, the computer system 800 may include an input device 812, such as a keyboard, and a cursor control device 814, such as a mouse. The computer system 800 can also include a disk drive unit 816, a signal generation device 818, such as a speaker or remote control, and a network interface device 820.

In a particular embodiment, as depicted in FIG. 8, the disk drive unit 816 may include a computer-readable medium 822 in which one or more sets of instructions 824, e.g. software, can be embedded. Further, the instructions 824 may embody one or more of the methods or logic as described herein. In a particular embodiment, the instructions 824 may reside completely, or at least partially, within the main memory 804, the static memory 806, and/or within the processor 802 during execution by the computer system 800. The main memory 804 and the processor 802 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions 824 or receives and executes instructions 824 responsive to a propagated signal, so that a device connected to a network 826 can communicate voice, video or data over the network 826. Further, the instructions 824 may be transmitted or received over the network 826 via the network interface device 820.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although the present specification describes components and functions that may be implemented in particular embodiments with reference to particular standards and protocols, the disclosed embodiments are not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be reduced. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above-disclosed subject matter is to be considered illustrative, and not restrictive, and the appended claims are intended to cover all such modifications, enhancements, and other embodiments that fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method of processing online advertisement selections, the method comprising:
detecting an electronic selection of an online advertisement, the electronic selection issued from a user computing device;
identifying an ad location, the ad location including an online site with which the user computing device is communicating at a time of the electronic selection of the online advertisement; and
storing a fraudulent click indicator in association with an identifier of the user computing device when the user computing device has not communicated with the ad location a threshold number of times within a first pre-defined period preceding the electronic selection.

2. The method of claim 1, further comprising storing a fraudulent user indicator in association with the identifier of the user computing device when a total number of fraudulent click indicators associated with the identifier of the user computing device meets or exceeds a pre-determined number of fraudulent click indicators.

3. The method of claim 1, further comprising determining whether the user computing device has communicated with the ad location within the first pre-defined period based at least partially on historical data associated with the user computing device.

4. The method of claim 3, further comprising determining whether a number of electronic selections of the online advertisement, related online advertisements, or a combination thereof, issued from the user computing device within a second pre-defined period of time exceeds a pre-determined number of selections, before determining whether the user computing device has communicated with the ad location the threshold number of times within the first pre-defined period.

5. The method of claim 3, further comprising determining whether a total number of electronic selections of all online advertisements issued from the user computing device within a second pre-defined period of time exceeds a pre-determined number of selections, before determining whether the user computing device has communicated with the ad location the threshold number of times within the first pre-defined period.

6. The method of claim 3, wherein the historical data includes a clickstream history associated with the user computing device.

7. The method of claim 1, wherein the online advertisement includes an embedded graphics link at the ad location.

8. The method of claim 1, wherein the ad location is a search engine site and wherein the online advertisement is displayed with search results of the search engine site in response to a current search query submitted to the search engine site from the user computing device.

9. The method of claim 8, further comprising:
identifying the current search query when the user computing device has communicated with the search engine site the threshold number of times within the first pre-defined period; and
storing a fraudulent click indicator in association with the identifier of the user computing device when the user computing device has not submitted at least one previous search query related to the current search query to the search engine site, to another search engine site, or any combination thereof, within a second pre-defined period of time.

10. A method of processing online advertisement selections, the method comprising:
detecting a hypertext transfer protocol (HTTP) request associated with an online advertisement, the HTTP request issued from a user computing device;
identifying an ad location corresponding to the online advertisement, the ad location comprising an online site with which the user computing device is communicating at a time of the HTTP request associated with the online advertisement; and
storing a fraudulent click indicator in association with an identifier of the user computing device, when a pre-defined number of previous HTTP requests issued from the user computing device do not include a threshold number of other HTTP requests associated with the online site.

11. The method of claim 10, further comprising receiving identification data related to the online site from an advertisement broker system, wherein the advertisement broker system stores data associating the online advertisement with the online site.

12. The method of claim 10, wherein the ad location is at least partially identified by a uniform resource locator (URL) corresponding to the online site.

13. The method of claim 10, wherein the online site is a search engine site and wherein the online advertisement is displayed via a search results page of the search engine site in response to a current search query submitted to the search engine site from the user computing device.

14. The method of claim 13, further comprising:
identifying the current search query when the pre-defined number of previous HTTP requests issued from the user computing device includes the threshold number of other HTTP requests associated with the search engine site;
determining whether the user computing device has submitted at least one previous search query related to the current search query to the search engine site, to another search engine site, or any combination thereof, within a pre-defined period of time; and
storing a fraudulent click indicator in association with the identifier of the user computing device, when the user computing device has not submitted at least one previous search query related to the current search query to the search engine site, to another search engine site, or any combination thereof, within the pre-defined period of time.

15. The method of claim 10, wherein the threshold number of other HTTP requests associated with the online site is equal to one.

16. A method of processing online advertisement selections, the method comprising:
detecting an electronic selection of an online advertisement, the electronic selection issued from a user computing device;
receiving data from an advertiser associated with the online advertisement, the data indicating user behavior associated with the user computing device prior to the electronic selection; and
selectively storing a fraudulent click indicator associated with the user computing device based on the data received from the advertiser.

17. The method of claim 16, wherein the data received from the advertiser includes an average number of times that the user computing device has communicated with an online site of the advertiser during a plurality of pre-defined periods preceding the electronic selection.

18. The method of claim 17, wherein the fraudulent click indicator is stored associated with the user computing device when the average number does not equal or exceed a threshold.

19. The method of claim 16, wherein the data received from the advertiser includes post-selection data associated with the user computing device, the post-selection data indicating fulfillment activities associated with prior communications between the user computing device and an online site of the advertiser.

20. The method of claim 19, wherein the fulfillment activities include requesting information about the advertiser, requesting information about a product or service of the advertiser, purchasing a product or service of the advertiser, or any combination thereof.

21. The method of claim 19, wherein the fraudulent click indicator is stored in association with the user computing device when the post-selection data does not indicate fulfillment activities associated with a pre-determined number of prior communications between the user computing device and an online site of the advertiser.

22. The method of claim 21, further comprising:
detecting at least one new fulfillment activity during a session between the user computing device and the online site of the advertiser, the session initiated as a result of the electronic selection of the online advertisement; and
removing the fraudulent click indicator from association with the user computing device in response to detecting the at least one new fulfillment activity.

23. A system to process online advertisement selections, the system comprising:
an analysis engine operable to:
receive data from a deep packet inspection (DPI) device indicating an electronic selection of an online advertisement issued from a user computing device;
retrieve historical data associated with the user computing device from a data store;
request data from an advertisement broker device identifying an online site with which the user computing device is communicating at a time of the electronic selection of the online advertisement;
determine, based on the historical data, whether the user computing device has communicated with the online site a threshold number of times within a pre-defined period preceding the electronic selection; and
store a fraudulent click indicator associated with an identifier of the user computing device, when the user computing device has not communicated with the online site a threshold number of times within a first pre-defined period preceding the electronic selection.

24. The system of claim 23, wherein the analysis engine is operable to determine whether a total number of selections of online advertisements issued from the user computing device exceed a threshold before retrieving the historical data associated with the user computing device.

25. The system of claim 23, wherein the analysis engine is operable to store a fraudulent click indicator in association with the identifier of the user computing device, though the user computing device has communicated with the online site the threshold number of times within the first pre-defined period preceding the electronic selection, when a number of successive selections of the online advertisement exceeds a second threshold number within a second pre-defined period

26. The system of claim 23, wherein the identifier of the user computing device includes an Internet protocol (IP) address.

27. The system of claim 23, wherein the analysis engine is operable to:
determine based on the historical data associated with the user computing device that the fraudulent click indicator stored in association with the identifier of the user computing device results in a total number of fraudulent click indicators associated with the user computing device to meet or exceed a pre-determined number; and
send data to the data store indicating that a fraudulent user status indicator is to be associated with the user computing device.

28. A computer-readable medium including processor-readable instructions adapted to cause a processor to execute a method comprising:
detecting an electronic selection of an online advertisement issued from a user computing device;
identifying an online site with which the user computing device is communicating at a time of the electronic selection of the online advertisement; and
storing a fraudulent click indicator in association with an identifier of the user computing device, when the user computing device has not communicated with the online site a threshold number of times within a first pre-defined period preceding the electronic selection.

29. The computer-readable medium of claim 28, further comprising processor-readable instructions adapted to access a clickstream history associated with the user computing device to determine whether the user computing device has communicated with the online site within the pre-defined period of time preceding the electronic selection.

30. The computer-readable medium of claim 28, further comprising processor-readable instructions adapted to store a fraudulent user indicator in association with the identifier of the user computing device when a total number of fraudulent click indicators associated with the user computing device meets or exceeds a pre-determined threshold.
